(19) United States
(12) Patent Application Publication
(10) Pub. No.: US 2007/0279301 A1
(43) Pub. Date: Dec. 6, 2007

(54) Window-Integrated Antenna in Vehicles

(76) Inventors: Markus Hoffmeister, Salzgitter (DE); Rainer Kuehne, Hannover (DE); Michael Thole, Hildesheim (DE)

Correspondence Address: KENYON & KENYON LLP, ONE BROADWAY, NEW YORK, NY, 10004, US

(21) Appl. No.: 10/581,817

(22) PCT Filed: Oct. 12, 2004
(86) PCT No.: PCT/EP04/52504

§ 371 Date: May 14, 2007

(30) Foreign Application Priority Data
Dec. 5, 2003 (DE) 10356830.1

(51) Int. Cl. H01Q 1/32

(52) U.S. Cl. 343/713

(57) ABSTRACT

In a window-integrated antenna in vehicles including a heating conductor field, which is provided for both FM reception as well as LMS reception, a decoupling element for the FM reception is provided which has a high-frequency, low-resistance, but non-galvanic connection to the heating conductor field.

### FIELD OF THE INVENTION

The present invention is directed to a window-integrated antenna in vehicles.

### BACKGROUND INFORMATION

The heating field of the window has been and is used as the antenna structure in window-integrated antennas in vehicles. U.S. Pat. No. 6,498,588 B1 discusses the heating field for both FM and TV reception. A conductor loop, which is not connected to the heating field, is additionally provided for LMS (long, medium, short wave) reception on the upper edge of the window.

A significant disadvantage of such a system is believed to be the necessity of a surface, e.g., in the upper area of the window, which, due to non-existing heating conductors, cannot be heated and therefore cannot be defrosted. The available heatable area may be unacceptably small, particularly in passenger cars having small windows.

The heating conductors run essentially horizontally and essentially parallel to the metallic boundaries of the window (body). Interference in the vehicle electrical system, transferred by the heating current to the heating conductors acting as the antenna, must, as is known, be suppressed via modules having a high-resistance behavior at high frequencies when the antenna connection point is galvanically linked to the heating field. For FM reception, these modules are one core double chokes, for example, which are integrated into the heating current-conducting conductor segments and, as a rule, are situated at the heating current terminals of the heating field. In addition, sufficient installation space must be made available for this.

In other vehicle antenna reception systems, the reception of LMS and diverse FM signals is implemented via conductor structures in one or multiple window panes which are for the most part situated in the immediate proximity of, but spatially separated from, one another. A significant disadvantage in such a system is the necessity of at least two, for the most part fixed, window panes, which results in increased expenses for the manufacture of the panes, for the electronic design of connected, for the most part active circuit components, and for the assembly of appropriate circuit carriers.

There are also antenna systems which form the antennas for LMS and FM reception from the galvanically contacted heating field. Here also, filter elements, which decouple the vehicle electrical system, are believed to be necessary in the heating current leads (European Patent Document No. 0382895 B1).

### SUMMARY OF THE INVENTION

The measures of the exemplary embodiment of the present invention, i.e., using a heating conductor field, which is provided at least for FM reception, but also for LMS reception, at least one decoupling element being provided for FM reception which has a high-frequency, low-resistance, non-galvanic connection to the heating conductor field, make it possible to receive LMS and diverse FM signals using a conductor structure in a single window pane which is applied through a single screen via a common screen printing method, without having to forego complete heating of the entire window, particularly in the area which is not covered by black print (outer edge of the window).

The conductor structure is applied to a window via common methods, it being irrelevant in terms of the exemplary embodiment of the present invention whether a single-pane safety glass or laminated safety glass is used. The window in question is surrounded by a metallic frame and is, for the most part, designed as the rear window of a motor vehicle. However, the described system may also be used on any other window, e.g., in ships.

The particular advantage of the exemplary embodiment of the present invention is that, in the case of LMS reception, no components are connected to the heating field acting as the antenna, which will be explained in the following.

The electronic components, connected for receiving FM and TV signals, may, in the case of LMS reception, be viewed as an equivalent capacitor between the antenna connection point and ground. Its capacitance is approximately in the range of 30 pF-40 pF. The reception capacitance of a rear window antenna, formed by the entire heating field, is in the range of 150 pF to 250 pF. This capacitance is unnecessarily increased by more than 10% due to connected electronic components, so that the LMS reception deteriorates because the reception signals flow off toward ground via the electronic module. This performance deterioration cannot be tolerated in regions where AM is heavily used (e.g., USA, Mexico). The equivalent capacitance of the connected electronic module is not effective for LMS frequencies due to a decoupling element having a high-frequency, low-resistance, non-galvanic contact, thus making the LMS reception optimal.

A further advantage of the exemplary embodiment of the present invention is cost-effective manufacture. In contrast to other embodiments, only one single window pane needs to be manufactured. Another advantage is the integrated and thus simple configuration of passive and active circuit components which provide separate signal paths for the different frequency bands, but which may be placed in one single housing. In addition to a minimum of mechanical components, this also results in minimal wiring in the vehicle and thus in substantial weight reduction.

Since the exemplary embodiment of the present invention does not call for any restrictions with regard to the design of the heating field, it is suitable, in particular, for use in motor vehicles having all types of windows.

### BRIEF DESCRIPTION OF THE DRAWINGS

FIG. 1 shows a block diagram of a window-integrated antenna according to the exemplary embodiment of the present invention.

FIG. 2 shows a window-integrated antenna including two decoupling elements for FM reception.

FIG. 3 shows a window-integrated antenna including a module carrier for a plurality of decoupling elements.

FIG. 4 shows a window-integrated antenna for supplying a diversity switching device.

FIG. 5 shows a window-integrated antenna including decoupling elements for other frequency ranges.

FIG. 6 shows a window-integrated antenna including an alternative arrangement of the decoupling element.

### DETAILED DESCRIPTION

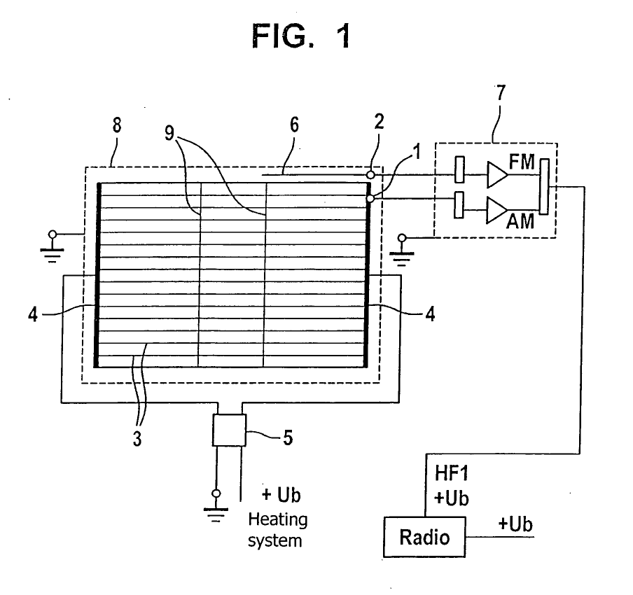

FIG. 1 shows a window-integrated antenna made up of heating conductors 3, running parallel to one another, which each meet a busbar 4 at their left and right ends. The heating conductor field formed in this way is supplied with heating current (Ub heating) via a filter element 5. Antenna connection point 1 is galvanically linked to the heating conductor field and implements the LMS reception. Contacting takes place at any point, may be, however, at the upper outer edge of the heating conductor field. Antenna connection point 2 is galvanically linked to a decoupling element 6. Decoupling element 6 may be made up of a conductor, which runs essentially parallel to at least one boundary of the heating conductor field which is not formed by busbars 4. The decoupling element may have any shape; it should, however, be a conductor formation made up of straight-line conductor segments. The FM reception is made possible via decoupling element 6. However, decoupling element/conductor formation 6 has a high-frequency, low-resistance, but non-galvanic connection to the heating conductor. Attention must be paid that the capacitive coupling between conductor formation 6 and metallic frame 8 surrounding the window is low enough for good reception characteristics. The design of the conductor formation, the length of the may be straight-line conductor segments and/or their geometrical position are established in such a way that resonant impedance is formed at antenna connection point 2 in the FM frequency range. Having a high-frequency, low-resistance, non-galvanic connection always means: For TV and FM frequencies, the coupling between the heating field and the decoupling element is as high as possible (S21<5 dB), for LMS frequencies the coupling is as low as possible (S21>15 dB). Under these circumstances, the FM/TV filter elements, necessary in a galvanically contacted heating field, may have smaller dimensions and thus become more cost-effective, or may even be dispensed with entirely.

Furthermore, to improve the reception quality, a plurality of essentially vertical antenna conductors 9 may be provided which are galvanically linked to heating conductors 3 at equi-potential points formed by the voltage distribution. The length of antenna conductors 9 and/or their geometrical position are defined by the fact that a resonance-like behavior of the antenna is established at antenna connection point 2 across the entire FM reception range. The resonance behavior of decoupling element 6 and antenna conductors 9 may be tuned due to a specific offset of the resonance frequencies in such a way that, compared to a single filter, an overall much wider resonance sharpness is established when two bandpass filters, tuned to each other, are used. This makes it possible to cover the entire FM range with respect to resonance sharpness.

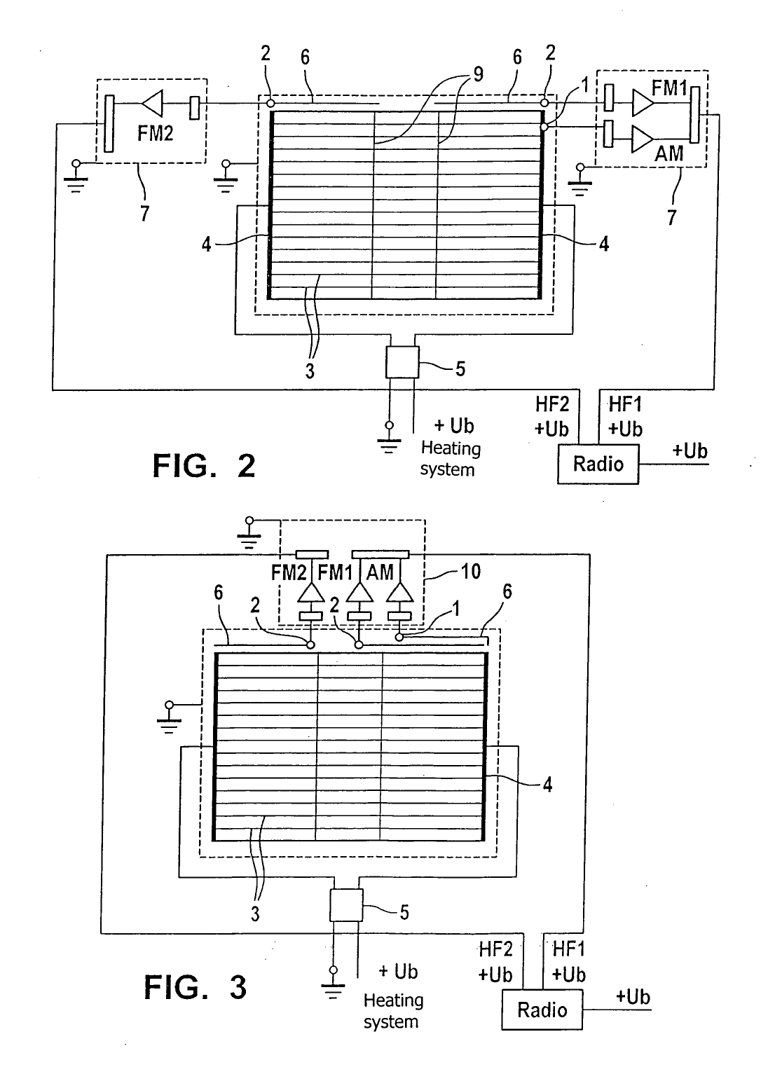

FIG. 2 shows a window-integrated antenna, configured as one shown in FIG. 1, with the difference that two decoupling elements 6 including their electronic modules 7 are situated on the upper edge of the heating conductor field left and right from one another. This makes it possible to scan another FM range, to operate a second FM receiver, or to utilize a diversity effect due to different reception signals at the two decoupling elements 6, which may occur under adverse reception conditions during mobile use.

FIG. 3 shows a window-integrated antenna according to the exemplary embodiment of the present invention in which antenna connection point 1 for LMS reception and antenna connection point 2 for FM reception are combined to form a shared mechanical component as the carrier of the electronic modules (shared module carrier 10). This design minimizes the mechanical complexity of the antenna system.

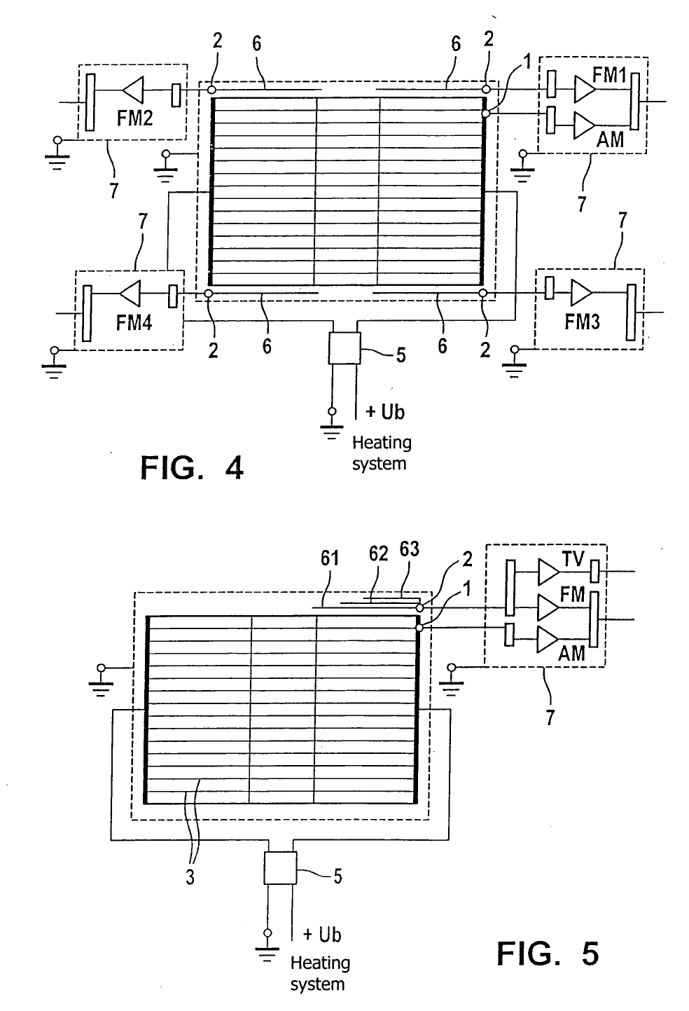

Four decoupling elements 6 for FM and one for LMS are provided in the design according to FIG. 4. This design is suitable for supplying a diversity switching device with four different antenna signals.

Multiple decoupling elements 61, 62, and 63, which are galvanically interconnected at their connection point 2, are provided in the design according to FIG. 5. Decoupling element/conductor 61 may be provided for FM reception and the other, in particular shorter, decoupling elements 62, 63 may be provided for TV reception in the VHF or UHF range. Decoupling elements 61, 62, 63 of different lengths may run parallel to one another.

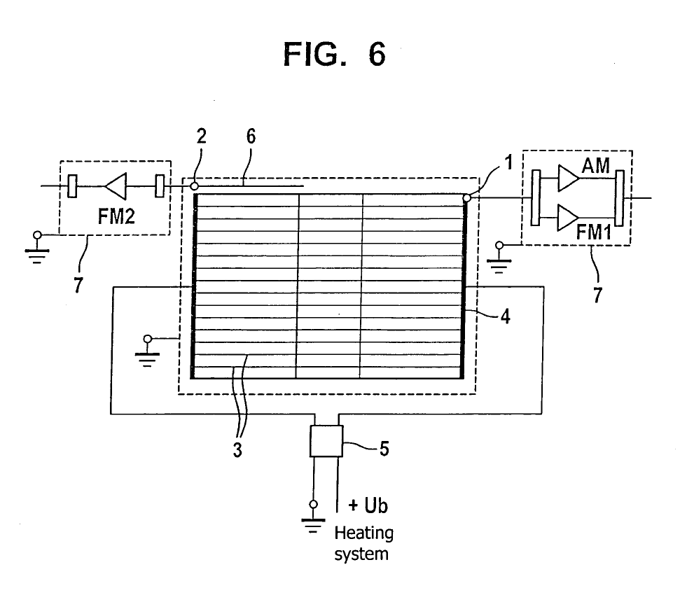

FIG. 6 shows another window-integrated antenna according to the exemplary embodiment of the present invention. Here, antenna connection point 1 is connected to an electronic module for LMS and FM signals. A second antenna is formed by decoupling element 6 and is connected to another module via antenna connection point 2. The capacitive load of the antenna in the case of LMS reception is optimized also in this case, because the second electronic module has a high-frequency, low-resistance connection to LMS frequencies.

Attention must be paid when designing different FM antennas that the level drops, which occur simultaneously both in the mobile and diversitary reception behavior, are minimized.

The described invention may also be used in a similar manner for differently designed heating conductor fields, e.g., when the heating conductors run vertically instead of horizontally. Furthermore, it is irrelevant whether there are divided or undivided heating conductor fields.

1-10. (canceled)

11. A window-integrated antenna for a vehicle, comprising:
a heating conductor field, which is provided for FM reception and LMS reception; and
at least one decoupling element for the FM reception which has a high-frequency, low-resistance, and non-galvanic connection to the heating conductor field.

12. The window-integrated antenna of claim 11, wherein the decoupling element for the FM reception includes at least one conductor situated essentially parallel to at least one boundary of the heating conductor field which is not formed by a busbar for the heating conductor field.

13. The window-integrated antenna of claim 11, wherein the decoupling element is arranged as to at least one of its length and position so that a resonant impedance behavior occurs in the FM frequency range at its connection end.

14. The window-integrated antenna of claim 11, wherein antenna conductors are situated in the heating conductor field essentially perpendicularly to heating conductors of the heating conductor field and are galvanically linked to the heating conductors.

15. The window-integrated antenna of claim 14, wherein the antenna conductors are arranged as to at least one of their length and position so that a resonance behavior of the antenna occurs at a connection end of the decoupling element in the FM range.

16. The window-integrated antenna of claim 11, further comprising:
at least one further decoupling element for a different frequency range.

17. The window-integrated antenna of claim 16, wherein the decoupling element for the FM reception and the at least one further decoupling element are galvanically connected at their connection ends.

18. The window-integrated antenna of claim 11, wherein multiple decoupling elements for the FM reception and further decoupling elements for other frequency ranges are connected to a diversity switching device.

19. The window-integrated antenna of claim 11, wherein a plurality of decoupling elements including the decoupling element for the LMS reception are connected to a shared module carrier.

20. The window-integrated antenna of claim 11, wherein a filter element is provided in a heating current circuit.
